(19) United States
(12) Patent Application Publication
(10) Pub. No.: US 2018/0213609 A1
(43) Pub. Date: Jul. 26, 2018

(54) HEATING PLATE

(71) Applicant: ZHONGSHAN SONGJING ELEC. CO., LTD, Zhongshan City (CN)

(72) Inventor: Songsheng OU, Zhongshan City (CN)

(21) Appl. No.: 15/412,570

(22) Filed: Jan. 23, 2017

(51) Int. Cl. H05B 3/68; H05B 3/02; H05B 3/32

(52) U.S. Cl. CPC H05B 3/686; H05B 3/32; H05B 3/026

(57) ABSTRACT

An embodiment of the present invention discloses a heating plate comprising a cast iron blank, a heat generating tube and a heat insulating powder layer. Wherein the upper surface of the cast iron blank is provided with a recess for placing a heat generating tube. Thereof a heat-generating tube is pressing-fitted into the recess and is fitted with the recess, and both ends of the heat-generating tube are respectively provided with a leading pin perpendicular to the horizontal plane. And the upper surface of the heat-insulating powder layer where is provided two pin holes respectively connected with the heat generating tube leading pins, and the leading pins pass through the lead pin holes. And it is an object of the present invention to provide a heating plate with high efficiency and high reliability.

### FIELD OF THE INVENTION

The present invention relates to the field of electric heating, and more particularly to a kind of heating plate.

### BACKGROUND OF THE INVENTION

Heating plates in the market using the current technology are electric heating furnace, electric tea stove, electric cooking pot and the like. The traditional heating plates are generally divided into two types: one is a pressing-tube heating plate and the other is a laiding-wire heating plate. Pressing-tube heating plate is made of heating tubes and metal shell, and most of the shell are made of aluminum alloy or cast iron. In the case of pressing-tube heating plate, the heating tubes are directly pressed and fixed into the heating plate. When it is under working situation, the internal temperature is high. Result from that the heating tube will be off or broken after many times of power-on and power-off, which will affect its service life. The structure of another kind of laiding-wire heating plate is that the heating plate will be coated with insulation powder, the heat will be spreaded into the internal space of structure, and then cover it inside the structure by the mean of insulation powder. The internal temperature of the product is lower than that of the heating plate of pressing-tube, and the life of product will be better. However, the structure and the process of manufacture is complicated, the time of manufacture is longer, the energy consumption is higher, the moisture-exhausting temperature is higher, and manufacturing and labor costs are higher. And in the condition of long-term storage, insulation powder will easily absorpt moisture, which make the product fail to pass the pressure test.

### SUMMARY OF THE INVENTION

The technical problem to be solved by the embodiments of the present invention is to provide a heating plate with high efficiency and high reliability.

The heating plate composed of a cast iron plate blank, a heating tube and a heat insulating powder layer. The upper surface of the cast iron plate blank is provided with recess for placing the heat generating tubes, and the upper surface of the cast iron plate blank is coated with a layer. The heating tube is pressing-fitted into the recess and matched with the recess, and the heating tube is provided with the pins which are perpendicular to the horizontal plane at both ends of the heating tube. The upper surface of the heat-insulating powder layer is provided with two leading holes fitting to the pins of heating tube thereto. And the leading pins passes through the leading holes.

The upper surface of the cast iron blank is provided with a spiral recess having a circular center in the center of the cast iron blank, the heating tube is of spiral, the spiral heat tube is engaged with recess in spiral shape. One of said leading pin is disposed on the first spiral recess adjacent the center of said cast iron blank and the other end is disposed in an outermost one of said spiral recesss.

The cast iron blank, having a thickness of 2.6 to 2.8 mm, is made of gray cast iron with a thickness of 14 to 15 mm.

The upper surface of the cast iron blank is in the form of a wave-like and concavo-convex shape, and the depth of the recess is 5 mm, which can closely fit with the heat generating tube.

The heating tube is made of iron-plated copper tube with a diameter of 6.6 mm. And the heating element in the heating tube is composed of a spiral heating wire wound by an iron-chromium-aluminum alloy wire. And the middle part of the heating tube is filled with middle and high temperature magnesium oxide Insulation material.

The coating layer is nanometer inorganic ceramic coating, and its thickness is 25-50 um.

The insulating layer is a composite material layer composed of quartz sand and kaolin material, and its thickness is 2-4 mm.

The embodiment of the present invention has the following beneficial effects:

The present invention, a heating plate, is provided with a cast iron blank, a heat generating tube and a heat insulating powder layer, so that the heat generating element has a double protection. This heating plate simplifies the production process, removes the high temperature sintering and stratification pressuring bottom process, shortens the production cycle time by 40%, decreases workers by about 60% under the same amount of production, reduces production consumption and labor costs, reduces the total cost by about 7%. In the performance of products, it solve the problems that, in a wet weather products stored for a long time will make them absorpt the moisture, which will make the products fail to pass the pressure test. While the direct heat-transferring efficiency of plate is higher, the time of boiling the water has also been improved, faster than the traditional heating plate about 1 minute. Changes in the structure extent the the product life by 30%. The surface is coated with nano-inorganic ceramic coating, greatly enhancing the performance of anticorrosive, antirust and high temperature resistance. Under the working condition, the heating element in the heating plate applies the iron chrome aluminum alloy resistance wire which has good heat generating performance and low cost. When in a energized state, the heating tube directly acts on the cast iron blank of heating plate, the heat-transferring efficiency is higher. The cast iron blank is made of gray cast iron with a thickness of 2.6-2.8 mm. It is not easily deformed and cracked at high temperature. The surface layer is of wave and thread shape, which increases the heating area and transfers the heat to the pot better. While the inner plate has insulation layer to keep warm, so that it is better to store heat within the plate by reducing the loss of heat, which makes the product be of better energy efficiency.

### BRIEF DESCRIPTION OF THE DRAWINGS

FIG. 1 is a schematic structural view of an embodiment of the present invention;

FIG. 2 is a schematic diagram showing the state of use of the embodiment of the present invention.

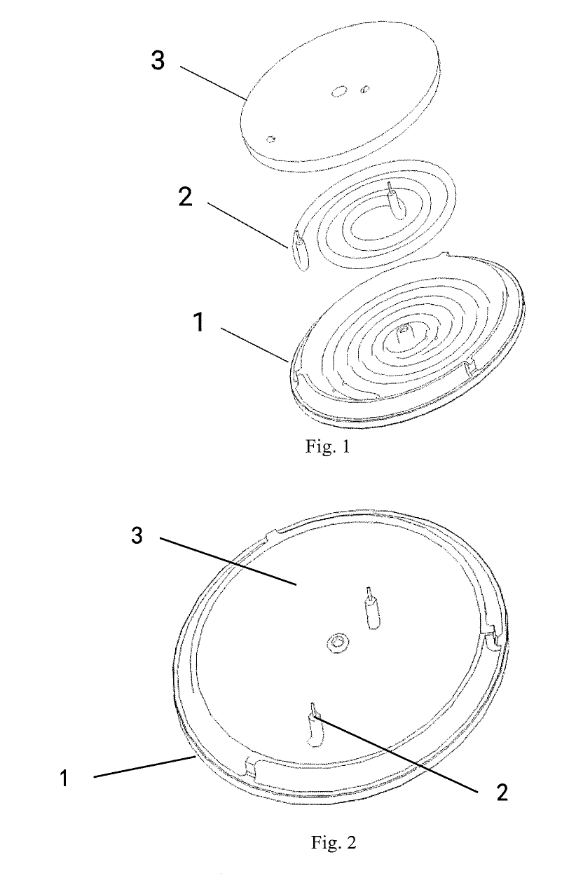

### DETAILED DESCRIPTION OF REPRESENTATIVE EMBODIMENTS

In order to better explain the objects, technical solutions and advantages of the present invention, the invention will be described in further details below with reference to the drawings.

The heating plate comprises a cast iron plate blank 1, a heat tube 2 and a heat insulating powder layer 3. The upper surface of the cast iron plate is provided with a recess for placing a heating tube, which is round spiral recess based on the center of the cast iron plate. The upper surface of the cast iron plate is coated with a coating layer with spiral heating tube. The spiral heating tube is engaged in the spiral recess. And the both sides of the heat tube are respectively provided with a lead post which is perpedicular to the horizen plate. The heat insulating powder layer is fixed with two holes for leading pin of the heating tube. And the leading pin is arranged to pass through the lead pin hole, and one of the pin-posts is arranged near the middle of the cast iron plate. And the other one is disposed in the outermost one of the spiral recesses of the cast iron blank. The flat thickness of cast iron plate blank is 14-15 mm. The cast iron blank is forged with gray cast iron with thickness of 2.6-2.8 mm. The upper surface of the cast iron blank is a wave-shaped concave-convex shape with a recess depth of 5 mm, which is tightly fitted with the heat generating tube. The heating tube is made of the iron-plated copper tube with the diameter of 6.6 mm. The heating element in the heating tube is made of iron-chrome aluminum alloy wire. The middle part of the heating tube is filled with high-temperature magnesium oxide insulating material. The coating layer is a nano inorganic ceramic coating, and its thickness is 25-50 um. Insulation layer is composed of quartz sand, kaolin material composition of the composite layer, and its thickness is 2-4 mm.

The present invention, a heating plate, has a structure of with a cast iron blank, a heat generating tube and a heat insulating powder layer, Which bring double protection to the heat generating element. This heating plate simplifies the production process, removes the high temperature sintering and pressure at the end of stratification process, which can shorten 40% of the production time. Under the same production amount the number of workers can decreased by about 60%, comprehensively reduce the total cost of production by 7%, including production consumption and labor costs. The traditional products stored in a wet weather for a long time will make the product absorpt moisture, result from that the product will fail to pass the pressure test. And the product successfully solve the problem. Meanwhile direct heat transferring efficiency of the surface of the plate will be higher. And the time to boil water has also been improved, faster than the traditional heating plate about 1 minute. Changes in the structure will extent the product life of 30%. The surface of nano-inorganic ceramic coating will greatly enhance the performance of product especially performance of anti-corrosion rust and high temperature performance. Under the working condition, the heating element in the heating plate uses the iron chrome aluminum alloy resistance wire which has good heat generating performance and low cost. After the power is applied, the heating tube directly heat the heating plate cast iron blank, the heat transfer efficiency is higher. The blank is made of gray cast iron with a thickness of 2.6-2.8 mm. It is not easily deformed and cracked at high temperature. The surface layer has a wave and thread shape, which increases the heating area and better transfers the heat to the pot. While the inner plate layer is of insulation, so that reducing the loss of heat and the heat can be stored better in the plate, which make the plate be of better energy efficiency.

The above disclosure is only a preferred embodiment of the invention and it is of course not intended to limit the claim scope of the invention. It is intended that the same changes be made within the scope of the invention as defined above shall be under the claims of this invention.

1. A heating plate characterized by comprising: a cast iron blank, a heat generating tube and a heat insulating powder layer. Wherein the upper surface of the cast iron blank is provided with a recess for placing the heat generating tube, and the upper face of the cast iron plate is sprayed. A heat-generating tube is press-fitted into the recess and is connected with the recess, and both ends of the heat-generating tube are respectively provided with a leading pin perpendicular to the horizontal plane. And in the upper surface of the heat-insulating powder layer, there are two leading holes which are fitted with the said leading pins respectively, and the said leading pins pass through said leading holes.

2. A heating plate according to claim 1, characterized by that said upper surface of said cast iron blank is provided with a spiral recess having a circular center point of said cast iron blank. The said heat generating tube being of a spiral shape. The heat generating tube which is fitted in the spiral recess. One of the leading pins is arranged on the first spiral recess near the center of the cast iron blank, and the other wire is arranged in the outermost spiral recess.

3. A heating plate according to claim 1, characterized by that the said cast iron blank has a flattening thickness of 14-15 mm and the said cast iron blank is made of gray cast iron having a thickness of 2.6 to 2.8 mm.

4. A heating plate according to claim 1, characterized by that the said upper surface of said cast iron blank is formed in a wave-like shape with recess in concavo-convex shape. And the recess has a depth of 5 mm for closely fitting with the heat generating tube.

5. A heating plate according to claim 1, characterized by that said heat generating tube is made of an iron-coated copper tube having a diameter of 6.6 mm and the said heating element in said heating tube is made of an iron-chromium-aluminum alloy in spiral shape. And the middle of the heat tube is filled with middle and high temperature magnesium oxide heat-insulation material.

6. A heating plate according to claim 1, characterized by that the said coating layer is a nano inorganic ceramic coating material having a thickness of 25 to 50 um.

7. A heating plate according to claim 1, characterized by that the said insulating layer is a composite material layer composed of quartz sand and kaolin material and has a thickness of 2 to 4 mm.
